(19) United States
(12) Patent Application Publication
(10) Pub. No.: US 2026/0227900 A1
(43) Pub. Date: Aug. 6, 2026

(54) TOUCH SCREEN INFORMATION INPUT METHOD FOR SMART DEVICE AND SMART DEVICE ITSELF

(71) Applicant: INGENICO (FUJIAN) TECHNOLOGY CO., LTD., Fuzhou, Fujian (CN)

(72) Inventors: Huifang CAI, Fuzhou, Fujian (CN); Xincheng ZENG, Fuzhou, Fujian (CN); Tao LI, Fuzhou, Fujian (CN); Luming YE, Fuzhou, Fujian (CN); Huangdian WU, Fuzhou, Fujian (CN)

(73) Assignee: INGENICO (FUJIAN) TECHNOLOGY CO., LTD., Fuzhou, Fujian (CN)

(21) Appl. No.: 19/150,943

(22) PCT Filed: Apr. 11, 2024
(86) PCT No.: PCT/CN2024/087111

§ 371 Date: Jul. 25, 2025

(30) Foreign Application Priority Data
May 23, 2023 (CN) 202310587431.1

(51) Int. Cl. G06F 3/04886; G06F 3/04847

(52) U.S. Cl. CPC G06F 3/04886; G06F 3/04847

(57) ABSTRACT

A touch screen information input method for visually impaired users to input information on a touch screen of smart device. The method involves gridding the touch screen into grid units arranged horizontally and vertically, with each grid unit corresponding to a virtual key, thereby exponentially increasing the available space (effective area) for the virtual key arrangement on the touch screen. As a result, even if the touch screen of smart device is small, a sufficient number of virtual keys can be arranged, and each virtual key occupies a large enough effective area, greatly reducing the probability of user maloperation and improving the convenience and reliability of use.

### FIELD

The present invention relates to the field of telecommunication technology, particularly to the field of information input security for smart device, and particularly to a touch screen information input method for smart device suitable for visually impaired individuals.

### BACKGROUND

At present, smart devices generally adopt the design of intelligent operating systems with touch screen input, and their rich application software and convenient operation design are gradually favored by the market. When inputting information on a smart device with touch screen, a virtual keyboard is usually displayed on the touch screen. Users can input information on the touch screen by touching/clicking on the displayed virtual keys (buttons), such as entering a PIN. This method is friendly to users with normal vision, but it poses certain operational difficulties for visually impaired individuals.

It is known that some smart devices provide sound reminder assistance while inputting on the touch screen to help visually impaired users correctly locate virtual buttons. But if audio reminders are used to assist visually impaired users in completing information input, it can easily cause security issues such as information leakage.

It is also known that some smart devices guide visually impaired users to locate virtual buttons on the touch screen through braille embossing set on the touch screen border (edges). However, in this way, the virtual buttons on the touch screen can only be arranged along the edges of the touch screen, which severely limits the layout design of the virtual buttons and causes waste in the large area of the central part of the touch screen. Moreover, if the touch screen is small, the arrangement of virtual buttons can be very crowded, and it may even be impossible to accommodate the required number of virtual buttons. In addition, due to the fact that all virtual buttons are concentrated around the edges of the touch screen, users are prone to accidental touching, greatly reducing the convenience and reliability of operation.

### SUMMARY

In view of the above-mentioned defects in the prior art, the present invention proposes a touch screen information input method with virtual keys arranged on the full screen. This method is configured for visually impaired user to input information on a touch screen of a smart device, wherein the smart device includes a touch screen and a security chip, and an outer edge of the touch screen of the smart device is provided with a positioning device for user touch sensing, the outer edge of the touch screen including: left and right edges set along a horizontal direction of the touch screen when the smart device is in normal use, and the upper and lower edges set along a vertical direction of the touch screen, characterized in that the touch screen is gridded into grid units arranged along the horizontal and vertical directions, each grid unit uniquely corresponding to a virtual key, the virtual key including information keys for inputting information and function keys for processing the input information, and the information keys are arranged in rows along the horizontal direction and in columns along the vertical direction.

The touch screen information input method comprises the following steps:
Step 1: After the application software on the smart device calls the SDK interface of the smart device, it enters information input mode, and the user can start inputting information.
Step 2: With the help of the positioning device, the user takes the positioning device as a starting point to perform a first touch slide along a horizontal direction on the touch screen, and performs a second touch slide along a vertical direction on the touch screen.
Step 3: Through the intersection of the row of the information key where the first touch slide is located and the column of the information key where the second touch slide is located, the security chip uniquely determines the grid unit where the intersection is located, thereby uniquely determining the information key corresponding to the grid unit, and using the content of the information key as the current input information.
Step 4: The user provides feedback on the current input information cross locked in step 3 to complete the input of the current input information, then, the security chip stores the current input information entered by the user and sends a first perception signal to the user to indicate that the user has completed the input of the current input information.
Step 5: Repeat steps 2-4 above until the user completes all information inputs through the function key and exits the information input mode.

The method described above grids (most or all) the touch screen into grid units arranged horizontally and vertically, with each grid unit corresponding to a virtual key, thus exponentially increasing the available space (effective area) for the virtual key arrangement on the touch screen. As a result, even if the touch screen of smart device is small, a sufficient number of virtual keys can be arranged, and each virtual key occupies a large enough effective area (or has a large enough gap between virtual keys), greatly reducing the probability of user maloperation and improving the convenience and reliability of use.

The effective area of virtual key refers to the effective area range of the screen occupied by a single grid unit in the gridded touch screen. That is to say, as long as the intersection point between the horizontal (transversal) direction where the user's first touch slide is located and the vertical direction where the second touch slide is located falls within the effective area range of the screen occupied by a grid unit, it is considered as the user's input to the virtual key corresponding to the grid unit. In addition, the input method by cross-locking virtual keys through twice touch slides in both horizontal (transversal) and vertical directions can further improve the accuracy of user touch input and reduce the probability of maloperation.

According to an embodiment of the present invention, the positioning device is distributed on at least one of the left and right edges of the touch screen, and the positioning device is distributed on at least one of the upper and lower edges of the touch screen.

According to an embodiment of the present invention, a uniquely corresponding positioning device is provided on the left edge and/or right edge in the horizontal direction corresponding to each row, and a uniquely corresponding positioning device is provided on the upper edge and/or lower edge in the vertical direction corresponding to each column.

It can be understood that the positioning device according to the present invention can be flexibly arranged in one or more directions on the outer edge of the touch screen according to actual needs, namely the upper edge, lower edge, left edge, and right edge. This falls within the scope of protection of the present invention.

According to a preferred embodiment of the present invention, the touch screen is provided with sensing areas at an extremity of the row and at an extremity of the column, and each sensing area does not overlap with each other. In fact, the security chip allocates a sensing area to each column and row of grid unit of the touch screen. Each sensing area has its own unique corresponding row or column, and does not overlap with each other. In this way, as long as the starting position of the user's touch slide is within a sensing area, even though the user's slide shifts to the range of another row or column corresponding to another sensing area in the subsequent touch slide operation, the security chip will always select only the row or column of the sensing area in the starting position as the judgment reference basis for cross locking a virtual key. As a result, it can further avoid system recognition errors caused by users' non-standard touch slide operation, reduce the probability of maloperation, and improve accuracy.

According to an embodiment of the present invention, the positioning device is a touch-sensitive embossed point. Preferably, the size of the embossed point located at the center position is larger than the size of the adjacent embossed point located at the lateral position. This makes it easier for users to locate the center position of the virtual key grid area.

According to an embodiment of the present invention, the function keys include a confirm key, in the process of the touch screen information input method, once the security chip receives input from the user with a touch on the confirm key, it checks whether the length of the information input data stored in the security chip memory reaches a preset effective length: if yes, the information input data or the encrypted information input data will be sent to the application software, and the application software will send a second perception signal to the user to indicate that the user has completed the information input and exit the information input mode; if not, the application software sends a third perception signal to the user to indicate that the information entered by the user has not reached the preset effective length.

According to an embodiment of the present invention, the function keys include a cancel key, in the process of the touch screen information input method, once the security chip receives input from the user with a touch on the cancel key, it clears all data stored in the security chip memory for the current information input and exits the information input mode.

According to an embodiment of the present invention, the function keys include a delete key, in the process of the touch screen information input method, once the security chip receives input from the user with a touch on the delete key, it checks whether there is information input data stored in the security chip: if yes, it clears the previous information input data and sends a fourth perception signal to the user; if not, no processing will be performed and a fifth perception signal will be sent to the user.

Preferably, the function keys are touch buttons and are located on the right side of the touch screen. It can be understood that the function keys can be set as separate simple touch buttons, and input can be completed with one single touch/click. It can also be set to be consistent with the information key, that is, input is completed through two touch swipes in the horizontal and vertical directions with a cross locking. This is within the scope of protection of the present invention.

According to an embodiment of the present invention, the information input mode is set with a timeout duration between 300 seconds and 600 seconds; when the security chip does not receive any input from the user for a time duration exceeding the timeout duration, it exits the information input mode.

Another aspect of the present invention also relates to a smart device comprising a touch screen, a storage device, and a processor, characterized in that the storage device stores a set of instructions suitable for running on the processor, and the set of instructions performs the touch screen information input method as described above when running on the processor.

The smart devices include POS devices, smartphones, mobile PCs, PAD devices, etc.

According to a preferred embodiment of the present invention, the smart device includes a peripheral frame bracket, wherein the frame bracket is fitted around the edge of the touch screen of the smart device, and a positioning device is arranged on the frame bracket.

### BRIEF DESCRIPTION OF THE DRAWINGS

The present invention will be further explained in detail below with reference to the accompanying drawings. It is easy for those skilled in the art to understand that these drawings are only for illustrative purposes and are not intended to limit the scope of protection of the present invention. The same reference numbers in the drawings indicate identical or similar components. For illustrative purposes, these drawings are not entirely drawn to scale.

FIG. 1 shows a front view of a POS device according to an embodiment of the present invention.

FIG. 2 shows a schematic diagram of a first touch sliding to lock the row of numeric keys during the process of entering the PIN on the POS device shown in FIG. 1.

FIG. 3 shows a schematic diagram of a second touch sliding to lock the column of numeric keys during the process of entering the PIN on the POS device shown in FIG. 1.

FIG. 4 shows a schematic diagram of the cross locking of numeric keys during the process of entering the PIN on the POS device shown in FIG. 1.

FIG. 5 shows a stereoscopic view of a POS device according to an embodiment of the present invention.

### DETAILED DESCRIPTION

In order to clarify the purpose, technical solution, and advantages of the embodiments of the present invention, the following will provide a clear and complete description of the technical solution in embodiments of the present invention in conjunction with the accompanying drawings. Obviously, the described embodiments are part of the implementations of the present invention, not all of them. Based on the embodiments in the present invention, all other embodiments obtained by those skilled in the art without creative labor fall within the scope of protection of the present invention. Therefore, the detailed description of the embodiments of the present invention provided in the accompanying drawings is not intended to limit the scope of the claimed invention, but only to represent the selected embodiments of the present invention. Based on the embodiments in the present invention, all other embodiments obtained by those skilled in the art without creative labor fall within the scope of protection of the present invention.

In the description of the present invention, the terms “first” and “second” are only used for descriptive purposes and cannot be understood as indicating or implying relative importance or implying the number of indicated technical features. Therefore, the features limited to “first” and “second” can explicitly or implicitly include one or more of these features. In the description of the present invention, “multiple” means two or more, unless otherwise specified.

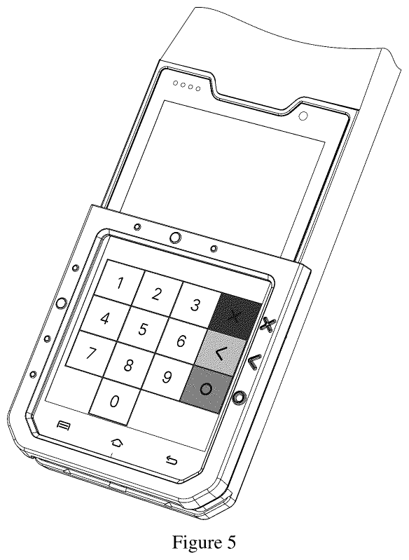

The following is based on a POS device with touch screen input (as shown in FIG. 5), and takes a visually impaired user entering PINs on the touch screen of the POS device as an example to specifically explain the information input method of the present invention and the smart device applying the method. It can be understood that the following explanation combined with embodiments does not constitute a limitation on the invention. Those skilled in the art can understand that in addition to entering the PIN, the method of the present invention can also be applied to scenarios such as account login, verification code input, etc. Generally speaking, any information input on touch screen of smart device can apply the method of the present invention. In addition, the smart devices involved are not limited to POS devices, and all smartphones, mobile PCs, PAD devices, etc. that support touch screen input are within the scope of protection of the present invention.

FIG. 1 shows a front view of a POS device 1 according to a preferred embodiment of the present invention. POS device 1 includes touch screen 2 and security chip (not shown). Users can input information on touch screen 2 by touching (clicking or sliding). In this embodiment, it aims to enter PINs. The information input by the user through touch screen 2 can be saved and processed in the security chip.

The touch screen 2 is gridded into grid cells arranged horizontally and vertically along the POS device 1 in normal use, with each grid cell uniquely corresponding to a virtual key (button). The virtual keys include information keys for inputting information, here are the numeric keys 22 from 0 to 9. The virtual keys also include function keys 23 for processing the input information. Here are three function keys 23 set on the right side of touch screen 2, wherein the function key with the symbol “x” corresponds to the delete key, the function key with the symbol “<” corresponds to the cancel key, and the function key with the symbol “○” corresponds to the confirm key, which are used to delete, cancel, and confirm the user's input information. The input of the numeric key 22 is completed by two touch slides in the horizontal and vertical directions on the touch screen 2 in a cross-locking manner. The function key 23 can be set to be the same as numeric key 22, which completes input through two touch slides in the horizontal and vertical directions in a cross-locking manner; or it can also be set as a separate simple touch button, which completes input through a single touch/click operation. In this embodiment, function key 23 is a simple touch button set on the right side of the touch screen 2. In addition, the function keys 23 are advantageously positioned around the touch screen and close to the edge, on any of the upper, lower, left, or right sides, and are not limited to the right side.

Preferably, as in this embodiment, a frame bracket 3 is also fitted around the outer periphery of the touch screen 2, which is equipped with a positioning device for touch sensing by visually impaired user, such as an embossed point 31. It can be understood that the above-mentioned positioning device can also be directly installed on the outer edge of the touch screen 2, without the need of additional frame bracket to be fitted around the periphery of the touch screen. The advantage of adding an additional frame bracket 3 (thereby setting the positioning device on the frame bracket) is that it standardizes the design and production of POS devices, allowing users to use identical POS devices regardless of their visual acuity. For visually impaired users, they only need to install an auxiliary frame bracket 3 on a normal standard POS device to use the same POS device as normal vision users. This eliminates the need to produce non-standard POS devices separately for visually impaired users, simplifies the production process, and saves costs.

As shown in FIG. 1, the embossed point 31 is arranged at the left and upper edges of touch screen 2, wherein the embossed point 31 on the left edge is aligned with the rows of the numeric keys 22 arranged in grid unit along the horizontal direction of touch screen 2 under normal use of POS device 1; the embossed point 31 on the upper edge is aligned with the columns of the numeric keys 22 arranged in grid unit along the vertical direction of touch screen 2. It can be understood that in other embodiments, the embossed point 31 can also be arranged at the right and lower edges of touch screen 2, or distributed on all four edges of touch screen 2. The arrangement of embossed point 31 can be flexibly set on the outer edge of touch screen 2 according to implementation needs. In addition, the form of the positioning device is not limited to embossed point, and other implementation methods known to those skilled in the art are also feasible, such as braille. In this embodiment, the positioning device is set as an embossed point because the setting of emboss is the most concise and practical, taking into account of the numeric key input method of cross-locking by two horizontal and vertical slides.

The setting of emboss can correspond only to the numeric keys 22 (information keys), or to all virtual keys (including function keys 23). In the former case, the numeric keys 22 complete the input by sliding horizontally and vertically twice in a cross-locking manner (hereinafter referred to as the cross-locking keys); and the function keys 23 are simple touch button that can be input with one single touch or click. In this case, the frame bracket 3 is also equipped with embossed symbols 32 corresponding to the function keys 23 that can be perceived by the user's touch, for the convenience of the user's touch positioning and recognition of the corresponding function keys 23. In the latter case, the number keys 22 and function keys 23 are all cross-locking keys, and all grid units of touch screen 2 are recognized as the same type by the security chip. Therefore, there is no need to set an embossed symbol 32 on the frame bracket 3, only embossed point 31 can be uniformly set.

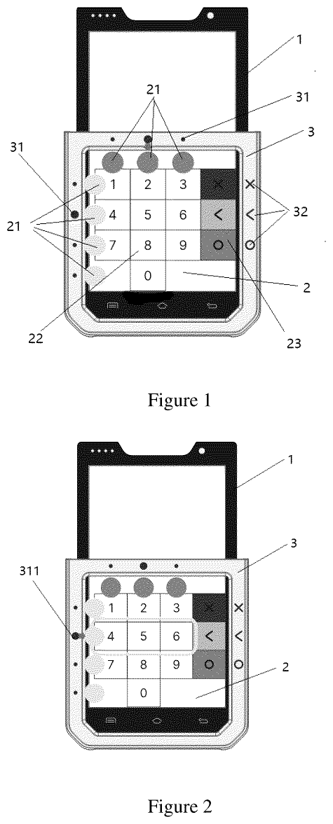

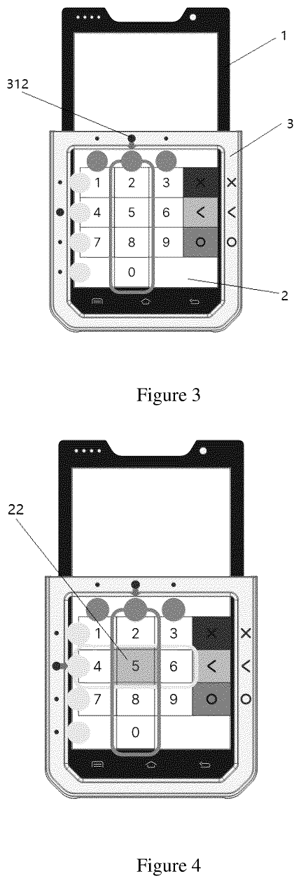

Preferably, the size of the embossed point located at the center position (i.e. the second embossed point 311 located on the left edge of touch screen 2 as shown in FIG. 2, and the middle embossed point 312 located on the upper edge of touch screen 2 as shown in FIG. 3) is larger than the size of the adjacent embossed point located at the lateral position. This makes it easier for users to locate the center position area of the virtual button grid area.

Preferably, in this embodiment, the touch screen 2 is further provided with sensing areas 21 at the extremity of the rows and the extremity of the columns of the numeric keys 22, and each sensing area 21 does not overlap with each other. The security chip allocates a sensing area 21 to each column and each row of the numeric keys 22 arranged in grid unit, and each sensing area 21 has its own unique corresponding row or column of numeric keys 22 and does not overlap with each other. In fact, the security chip identifies the touch slide event based on the distance and time from when the finger touches the touch screen to when it slides away from the screen, and records the touch slide event including the starting position of the touch slide. Touch slide (or touch swipe) is manually controlled and cannot be completely perpendicular or parallel to the screen borders (edges or frame), so it is necessary to allow for errors in the sliding direction. In this embodiment, the security chip uses the coordinate value of the starting part of the slide, that is, the coordinate value within the sensing area 21 in FIG. 1, as the judgment reference basis, and the upper and lower displacement deviation of the slide outside the sensing area is not included in the judgment reference basis. At the same time, there is no limit on the sliding distance, and it can be any distance from the start of the sensing area to the edge of the opposite side of the touch screen. In this way, as long as the starting position of the user's touch slide is within this sensing area, even if the user's slide shifts to the range of the row or column corresponding to another sensing area in the subsequent touch sliding process, the security chip always selects only the row or column of the sensing area in the starting position as the reference basis for cross locking the numeric key. As a result, it can further avoid system recognition errors caused by users' non-standard touch slide, reduce the probability of maloperation, and improve accuracy.

Based on the POS device 1 shown in FIG. 1, taking a visually impaired user entering PIN 5238 on the POS device 1 as an example, and combined with the accompanying drawings, the touch screen information input method according to the present invention is explained in detail:
Step 1: Visually impaired user starts the application software on POS device 1. After calling the SDK interface of POS device 1, the application software enters the information input mode for visually impaired user, and the user can start entering the PIN.
Step 2: The user uses the second embossed point 311 located on the left edge of the touch screen 2 on the frame bracket 3 to locate the second row of the numeric keys as shown in FIG. 2, which is enclosed by a solid line. Starting from the second embossed point 311, the user implements a first touch slide (or swipe) from left to right along the horizontal direction on the touch screen 2. Then, with the help of the middle embossed point 312 located on the upper edge of the touch screen 2 and set on the frame bracket 3, the user locates the middle column of the numeric keys as shown in FIG. 3, which is enclosed by a solid line. Starting from the middle embossed point 312, the user implements a second touch slide (or swipe) along the vertical direction of the touch screen 2 from top to bottom on the touch screen 2. It should be noted that if the user makes two or more touch slides in the same direction (horizontal or vertical), the security chip will recognize the last touch slide in that direction as an effective operation and record the coordinate position of the last touch slide on the touch screen.
Step 3: As shown in FIG. 4, at the intersection of the row (horizontal direction) of the numeric keys where the first touch slide is located and the column (vertical direction) of the numeric keys where the second touch slide is located, the security chip uniquely determines the grid unit where the intersection point is located, and then uniquely determines the numeric key 22 corresponding to the grid unit, which is the numeric key “5”, and uses “5” as the current input information.
Step 4: The user provides feedback on the current input information “5” that was cross locked in step 3 to complete the entry of the current input information into the security chip. At this time, the security chip stores the current input information “5” entered by the user and sends a first perception signal to the user to remind him that the user has completed the entry of the current input information. It should be noted that users can use one of the following four methods to provide feedback on the input information: clicking on any point on the screen, double clicking on any point on the screen, long pressing on the screen, and default selection. The first perception signal can include: buzzer sound, screen vibration, voice prompts, etc.
Step 5: Repeat steps 2-4 above, and enter the PINs “2”, “3”, and “8” in the security chip by using the cross locking numeric keys “2”, “3”, and “8” in sequence. Finally, the user clicks on the function key “○” (as shown in FIG. 1) on the right side of touch screen 2, which is the confirm key, to confirm the completion of the PIN input (end the information input) and exit the information input mode. The function key “○” (confirm key) can guide positioning through the corresponding embossed symbol 32 “○” set on the frame bracket 3.

Preferably, in step 5 above, once the security chip receives input from the user by touching/clicking the function key “○”, it checks whether the length of the information input data stored in the security chip memory reaches the preset effective length (the security chip allows the user to set the effective length of the information input data, and the user can choose to set the effective length to 0, 4, 5, 6, 7, 8, 9, 10, 11, 12, with a maximum value of 12): If yes, the input data of the information or the encrypted input data of the information will be sent to the application software, which will then send a second perception signal (such as buzzer sound, screen vibration, voice prompt, etc.) to the user to remind them that the information input has been completed and exit the information input mode; If not, the application software will send a third perception signal to the user (such as buzzer sound, screen vibration, voice prompt, etc.) to remind the user that the input information has not reached the preset limited length.

Preferably, in steps 1-5 above, the user can also delete the previously entered PIN by touching and clicking the function key “x”. Once the security chip receives input from the user who has touched and clicked the delete function key “x”, it checks whether there is PIN input data stored in the security chip. If yes, it clears the previous PIN input data and sends a fourth perception signal to the user; If not, no processing will be performed and a fifth perception signal will be sent to the user.

Preferably, in steps 1-5 above, the user can also cancel the PIN input operation at any time by touching and clicking the function key “<”. Once the security chip receives input from the user who has touched and clicked the cancel function key, it will clear all the data stored in the security chip's memory for the current PIN input and exit the information input mode.

It should be noted that users can also use one of the following four methods to provide feedback on the input of touching and clicking on the above function keys: clicking on any point on the screen, double clicking on any point on the screen, long pressing on the screen, and default selection.

Preferably, in steps 1-5 above, the PIN input mode for visually impaired user is set with a timeout duration, which is between 300 seconds and 600 seconds. When the security chip does not receive any input from the user for a time duration exceeding the timeout duration, it exits the PIN input mode.

According to another aspect of the present invention, in an embodiment not shown, there is provided a smart device comprising a touch screen, a storage device, and a processor, characterized in that the storage device stores a set of instructions suitable for running on the processor, and the set of instructions performs a touch screen information input method as previously described when running on the processor.

The accompanying drawings and the above description describe non limiting specific embodiments of the present invention. In order to teach the principles of invention, some conventional aspects have been simplified or omitted. Those skilled in the art should understand that variations originating from these embodiments fall within the scope of the present invention. Those skilled in the art should understand that the above features can be combined in various ways to form multiple variants of the invention. Therefore, the present invention is not limited to the specific embodiments mentioned above, but is only limited by the claims and their equivalents.

1.-14. (canceled)

15. A touch screen information input method, configured for visually impaired user to input information on a touch screen of a smart device, wherein the smart device includes a touch screen and a security chip, and an outer edge of the touch screen of the smart device is provided with a positioning device for user touch sensing, the outer edge of the touch screen including: left and right edges set along a horizontal direction of the touch screen when the smart device is in normal use, and the upper and lower edges set along a vertical direction of the touch screen, characterized in that the touch screen is gridded into grid units arranged along the horizontal and vertical directions, each grid unit uniquely corresponding to a virtual key, the virtual key including information keys for inputting information and function keys for processing the input information, and the information keys are arranged in rows along the horizontal direction and in columns along the vertical direction;
the touch screen information input method comprising the following steps:
step 1: after the application software on the smart device calls the SDK interface of the smart device, it enters information input mode, and the user can start inputting information;
step 2: with the help of the positioning device, the user takes the positioning device as a starting point to perform a first touch slide along a horizontal direction on the touch screen, and performs a second touch slide along a vertical direction on the touch screen;
step 3: through the intersection of the row of the information key where the first touch slide is located and the column of the information key where the second touch slide is located, the security chip uniquely determines the grid unit where the intersection is located, thereby uniquely determining an information key corresponding to the grid unit, and using the content of the information key as a current input information;
step 4: the user performs a feedback operation on the current input information cross locked in step 3 to complete the input of the current input information, then, the security chip stores the current input information input by the user and sends a first perception signal to the user to indicate that the user has completed the input of the current input information;
step 5: repeat steps 2-4 above until the user completes all information inputs through a function key and exits the information input mode.

16. The touch screen information input method according to claim 15, wherein the positioning device is distributed on at least one of the left and right edges of the touch screen, and the positioning device is distributed on at least one of the upper and lower edges of the touch screen.

17. The touch screen information input method according to claim 16, wherein a uniquely corresponding positioning device is provided on the left edge and/or right edge in the horizontal direction corresponding to each row, and a uniquely corresponding positioning device is provided on the upper edge and/or lower edge in the vertical direction corresponding to each column.

18. The touch screen information input method according to claim 15, wherein the touch screen is provided with sensing areas at an extremity of the row and at an extremity of the column, and each sensing area does not overlap with each other.

19. The touch screen information input method according to claim 15, wherein the positioning device is a touch-sensitive embossed point.

20. The touch screen information input method according to claim 19, wherein the size of the embossed point located at the center position is larger than the size of the adjacent embossed point located at the lateral position.

21. The touch screen information input method according to claim 15, wherein the function keys include a confirm key, in the process of the touch screen information input method, once the security chip receives input from the user with a touch on the confirm key, it checks whether the length of the information input data stored in the security chip memory reaches a preset effective length: if yes, the information input data or the encrypted information input data will be sent to the application software, and the application software will send a second perception signal to the user to indicate that the user has completed the information input and exit the information input mode; if not, the application software sends a third perception signal to the user to indicate that the information entered by the user has not reached the preset effective length.

22. The touch screen information input method according to claim 15, wherein the function keys include a cancel key, in the process of the touch screen information input method, once the security chip receives input from the user with a touch on the cancel key, it clears all data stored in the security chip memory for the current information input and exits the information input mode.

23. The touch screen information input method according to claim 15, wherein the function keys include a delete key, in the process of the touch screen information input method, once the security chip receives input from the user with a touch on the delete key, it checks whether there is information input data stored in the security chip: if yes, it clears the previous information input data and sends a fourth perception signal to the user; if not, no processing will be performed and a fifth perception signal will be sent to the user.

24. The touch screen information input method according to claim 15, wherein the function keys are touch buttons set on the right side of the touch screen.

25. The touch screen information input method according to claim 15, wherein the information input mode is set with a timeout duration between 300 seconds and 600 seconds; when the security chip does not receive any input from the user for a time duration exceeding the timeout duration, it exits the information input mode.

26. A smart device comprising a touch screen, a storage device, and a processor, characterized in that the storage device stores a set of instructions suitable for running on the processor, and the set of instructions performs the touch screen information input method according to claim 15 when running on the processor.

27. The smart device according to claim 26, comprising a POS device, a smartphone, a mobile PC and a PAD device.

28. The smart device according to claim 26, wherein the smart device includes a frame bracket fitted around an edge of the touch screen of the smart device, and a positioning device is arranged on the frame bracket.
